(19) United States
(12) Patent Application Publication
(10) Pub. No.: US 2015/0057055 A1
(43) Pub. Date: Feb. 26, 2015

(54) APPARATUS AND METHODS TO ELIMINATE OR REDUCE GARBLING IN ELECTRONIC COMMUNICATIONS EQUIPMENT

(71) Applicant: PJB Safety Institute, LLC, Hummelstown, PA (US)

(72) Inventors: William Torregrossa, Hummelstown, PA (US); Patrick Leonard, Hershey, PA (US); James Blaser Leonard, Hummelstown, PA (US)

(73) Assignee: PJB Safety Institute LLC, Hummelstown, PA (US)

(21) Appl. No.: 13/970,840

(22) Filed: Aug. 20, 2013

(51) Int. Cl. H04B 1/38

(52) U.S. Cl. CPC H04B 1/3888
USPC 455/575.8

(57) ABSTRACT

Provided herein are new apparatus and methods relating to the protective covering of remote speaker microphones of two-way radio systems, including radio systems used and worn by emergency response personnel in extreme environments such as structure fires, among others. The apparatus and methods eliminate or reduce the accumulation of water, dust, and debris, thereby reducing or eliminating garbled communications from the user that would otherwise result from the blocking of sound to the microphone by water, dust, or debris. Such garbled communications pose a significant threat to the user, especially in hostile environments where effective and reliable radio communication is a matter of life and death.

### CROSS-REFERENCE TO RELATED APPLICATIONS

None.

### FIELD

This application describes apparatus and methods relating to electronic communication systems, including portable radio communications equipment such as that used by emergency responders, including police, fire ambulance, soldiers, sailors, explorers, and other persons in needed of reliable performance of microphones and other transmission equipment in any environment.

### BACKGROUND

Two-way communication involving radio systems are known for use by military, emergency response, and other personnel. Such systems include handheld radios and portable radios, as well as installed two-way operators in vehicles of all types, as well as for table-top units used for safety and security in buildings, for example. For example, portable radios often include clips or holsters for wearing by a user, and some also include, as coiled wire that permits mounting of a microphone transmission unit on a user's shoulder or torso. Policemen and firemen frequently utilize the shoulder-mounted transmission unit, since it holds the microphone in a convenient location relative to the ear for listening, as well as in a location for voice-activated (“VOX”) and/or manual operation (such as by single-hand operation cross-body) by depressing a button or switch. The wearing of a microphone transmission unit in such a manner has the disadvantage of exposing the microphone transmission unit to the elements, such as water (from rain, splashing, firehose spray, etc.), debris (dust, smoke, exhaust, etc.). While manufacturers of microphone transmission units have endeavored to make the units resistant to allowing water and debris into the sensitive internal electronics, the water and debris often deposit on the exterior surface of the microphone unit during use. This condition results in a condition referred to herein as “garbling”—preventing a user's voice from clearly and cleanly being picked up by the microphone for transmission to another radio. This unsafe garbling condition puts emergency personnel at risk of being unable to effectively communicate by radio, often in extreme conditions when safety is a matter of life and death. More on this condition is included in Appendix A hereof, which includes a statement of inventor Pat Leonard. The inventors herein have conceived of a solution to the longstanding and unsolved condition of garbling in radio communications.

### BRIEF DESCRIPTION OF THE DRAWINGS

FIG. 1 illustrates a typical radio and microphone apparatus compatible with the protective covering apparatus and methods in accordance with the present invention.

FIG. 2 illustrates a typical body-mounting user setup for the typical radio and microphone apparatus of FIG. 1, which is compatible with use of the protective covering apparatus and methods in accordance with the present invention.

FIGS. 3a-3b illustrate an example of the protective covering apparatus and its methods of manufacture in accordance with the present invention.

FIGS. 4a-4k illustrate exemplary method of manufacture and installation of protective coverings in accordance with the present invention.

### DETAILED DESCRIPTION

As previously described, two-way communication involving radio systems are known for use by military, emergency response, and other personnel. Such radio systems include handheld radios and portable radios, as well as installed two-way operators in vehicles of all types, as well as for table-top units used for safety and security in buildings, for example. For example, portable radios often include clips or holsters for wearing by a user, and some also include a coiled wire that permits mounting of a microphone transmission unit on a user's shoulder or torso. Policemen and firemen frequently utilize the shoulder-mounted transmission unit, since it holds the microphone in a convenient location relative to the ear for listening, as well as in a location for voice-activated (“VOX”) and/or manual operation (such as by single-hand operation cross-body) by depressing a button or switch. The wearing of a microphone transmission unit in such a manner has the disadvantage of exposing the microphone transmission unit to the elements, such as water (from rain, splashing, firehose spray, etc.), debris (dust, smoke, exhaust, etc.). While manufacturers of microphone transmission units have endeavored to make the units resistant to allowing water and debris into the sensitive internal electronics, the water and debris often deposit on the exterior surface of the microphone unit during use. This condition results in as condition referred to herein as “garbling”—preventing a user's voice from clearly and cleanly being picked up by the microphone for transmission to another radio. This unsafe garbling condition puts emergency personnel at risk of being unable to effectively communicate by radio, often in extreme conditions when safety is a matter of life and death.

The inventors herein have conceived of solutions to the longstanding problem of garbled transmissions. The apparatus and methods herein are examples of the conceived solutions, but are non-limiting thereof.

While it is known to make the outside housing or casing of a portable radio water-resistant to protect the sensitive interior electronic components, the microphone of such units must remain unobstructed to provide effective use, whether by VOX or by manual activation by a user. The inventors herein include seasoned firefighters who have used many portable radios, and who have experienced garbled communications regardless of model and make of the radios and the associated microphone transmission units. Garbled communications have been experienced and witnessed in environments ranging from mild (rainfall) to severe (inside burning buildings with water spraying and dripping from firehoses and with heavy ash and smoke in the surrounding air). The inventors have confirmed that in such environmental use, the microphone transmission unit often gathers a layer of water, ash, dust, or other debris that blocks or otherwise interferes with sound reaching the microphone. That condition is unacceptable, and results in the user's voice being inaudible, muffled, or garbled to another user receiving their radio transmission. The following apparatus and methods mitigate or eliminate the layers of water and debris on a microphone transmission units, thereby reducing or eliminating inaudible, muffled, or garbled radio communications.

Examples. As generally shown in the accompanying drawings, protective covering apparatus are provided to protect microphone transmission units from wet, dusty, and other unfriendly environmental conditions, thereby mitigating or eliminating layers of water and debris on a microphone transmission units that otherwise interfere with proper microphone receipt of sound from a user and his/her environment. In one example, the apparatus comprises a protective covering that prevents water, dust, or other debris from covering the microphone of radio transmission unit. The protective covering is selected to allow sound to pass through the covering, while not allowing water, dust, or debris to pass through the covering. Suitable covering materials include textiles (woven and non-woven) that are water-resistant and/or waterproof, yet porous to sound, and also preferably porous to air. For example, a suitable textile includes woven natural, synthetic (or combinations thereof) fibers woven so that any inter-fiber pores provided are small enough to prevent the transmission of water through the textile at ambient conditions, and preferably also to prevent water transmission and/or permeation under pressure greater than ambient pressure, and most preferably at pressures greater than 10 to about 300 psi. The textile or any of its fibers may further include one or more chemicals or coatings to repel or resist penetration by water, fluids, dust or debris—such as a polytetrafluroethylene (PTFE) coating, such as TEFLON brand PTFE coatings by DuPont.

In prototype work, the inventors sought a cost effective material which would be waterproof but still allow good sound transmission. Several waterproof materials were selected for evaluation. Several stretch fabrics were tried but didn't offer the desired level of waterproofing. A super waterproof/breathable GORETEX® brand textile material by WL Gore Co. (Wilmington, Del.) (2 ply) worked well against the key criteria, but may be too expensive for commercial manufacturing, depending upon the final market and sales pricing. Another textile evaluated was Ultrex® brand textile by Seattle Fabrics, Inc. (Seattle, Wash.). Ultrex® brand 3-Ply material is specified by the manufacturer as comprising a three-part system of densely woven fabric, micro-porous polyurethane coating and a DWR (durable water repellent) finish to provide a waterproof, windproof, and breathable fabric system that is durable. This Ultrex® 3-ply material was tested and worked well to repel water and dust, but was found to slightly degrade the sound quality, possibly due to thickness of three plies, which also presented challenges to forming and sewing to fit small RSM units.

Conversely, Ultrex® 2 ply material was found to be more appropriate, since it allowed for a waterproof, form fitting, easy to sew textile while still allowing for excellent sound quality. The Ultrex® 2-Ply material is specified by its manufacturer as a two-part system of densely woven fabric, micro-porous polyurethane coating and a durable water repellent finish. It was found to provide waterproof windproof, and breathable fabric system that is durable. Other suitable materials evaluated included a Super Waterproof/Breathable-Tex (2-Ply), specified by Seattle Fabrics Inc. to be waterproof, breathable and windproof, with the two-ply version having a face fabric and a micro porous Teflon® brand PTFE membrane.

Other materials are compatible with the inventive concepts herein, with the essential criteria being resistance to penetration by water and debris, as well as good permeation of sound through the material. Other desirable qualities include forming with resistance to bunching, UV or heat degradation, tearing, sliding, or deformation in emergency response, military, and other extreme environments, as well as in ambient conditions encountered by users of the radio devices to be protected by the Garble Guard™ brand protective apparatus and methods described herein.

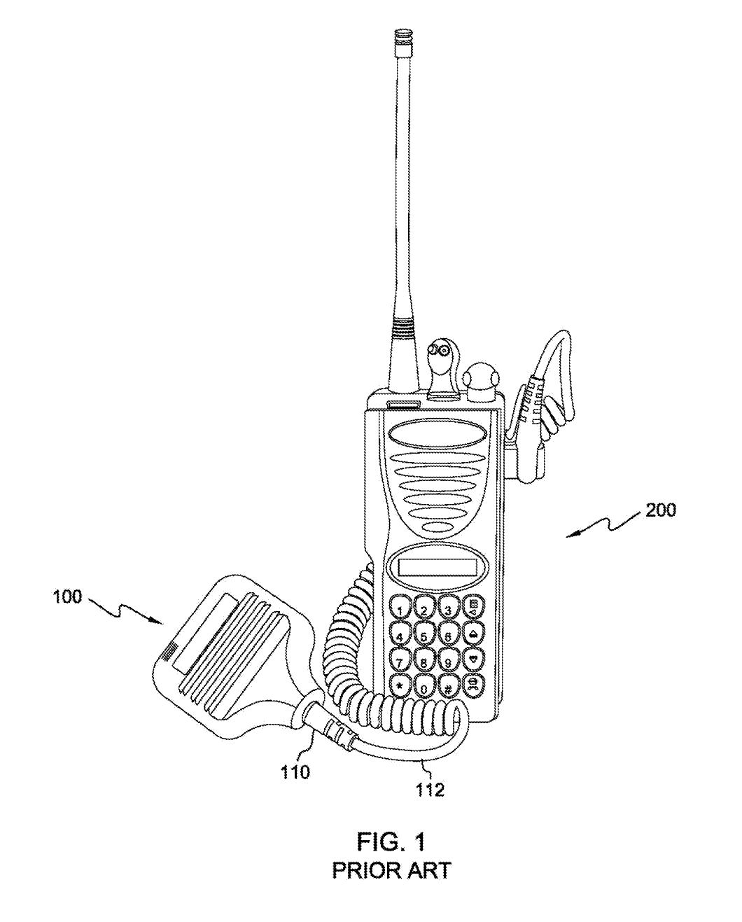

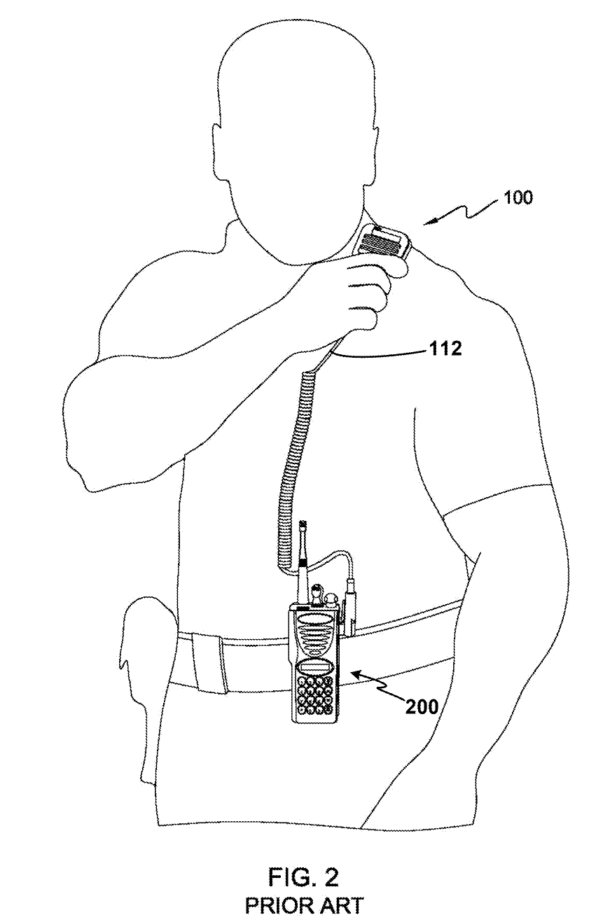

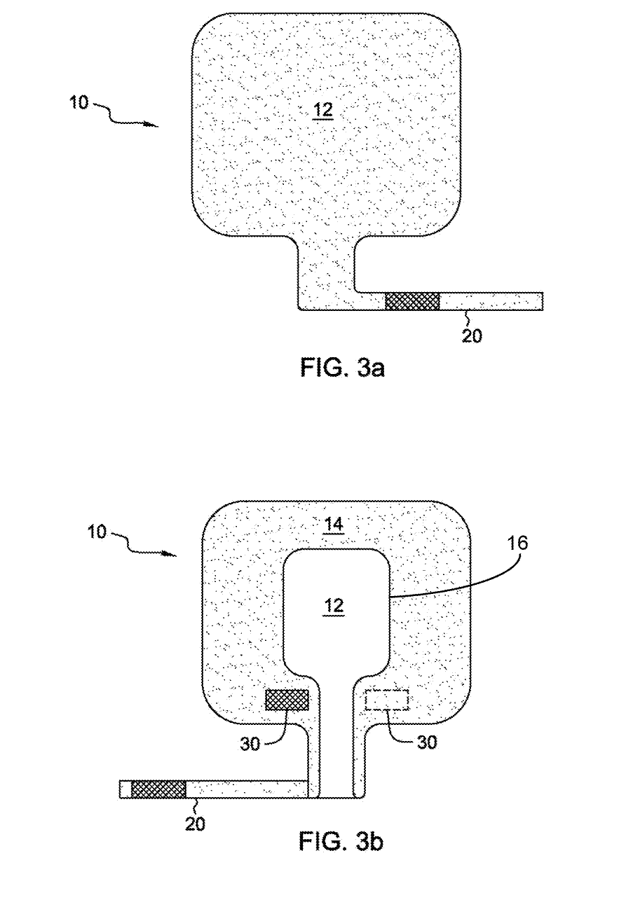

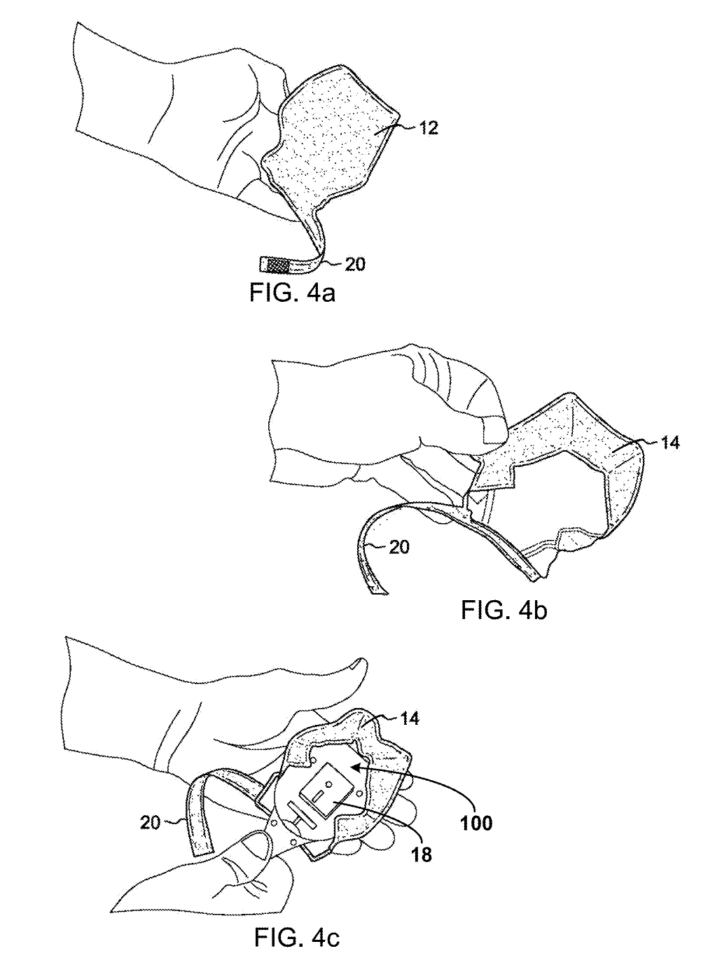

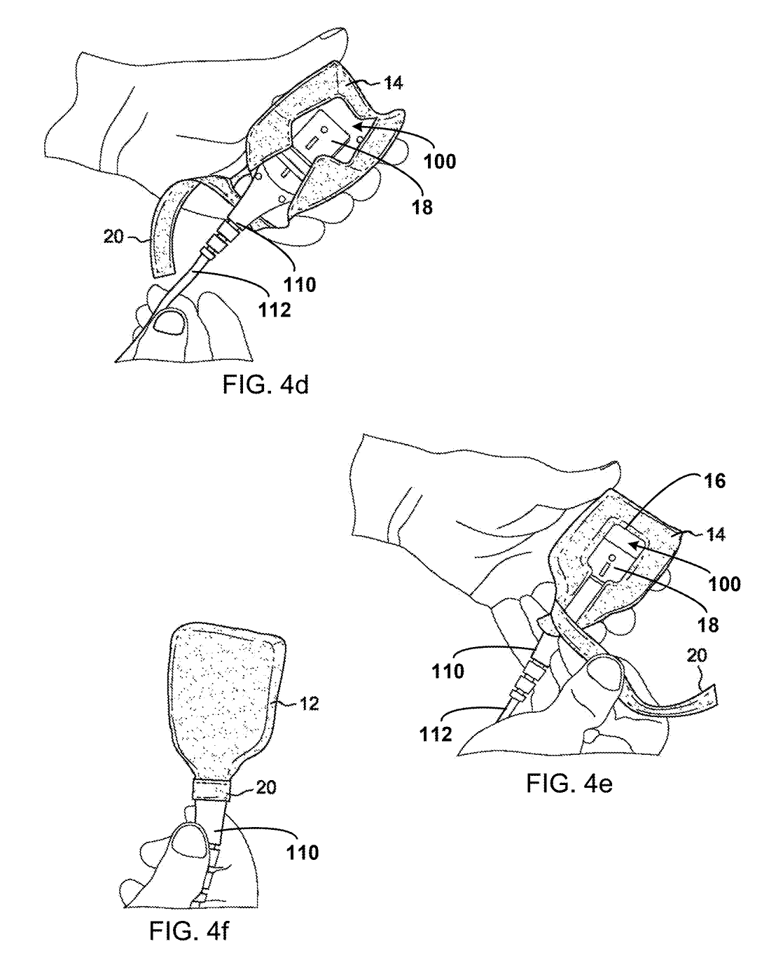

As generally shown in FIGS. 3a-3b, as well as in FIGS. 4a-4k, the protective covering apparatus is designed to cover the area of a microphone transmission unit of an RSM, for example. The apparatus may optionally cover additional areas of the transmission unit, such as the housing, cord transition, cord connection, and cord, for example. In a preferred embodiment, the covering substantially surrounds the transmission unit, but does not interfere with the factory standard or other desired mounting of the unit (such as in a shoulder harness, belt harness, clip, holster, or other mounting means provided by the manufacturer or a user). By way of illustrative example, the apparatus and methods are compatible with the exemplary shoulder-mounted microphone transmission units, such as the Motorola® brand Remote Speaker Microphone (“RSM”) assemblies shown in FIGS. 1-2, as well as other such RSMs commonly used by firefighters, emergency response personnel, and other civilian and military personnel.

As further shown in FIG. 2, such RSM units are commonly worn on the left shoulder for easy cross-body activation, by a user's opposite (right) hand, or optionally for VOX activation (hands free). However, this location leaves the RSM exposed to rain, water splashes, dust, debris, and other potentially infiltrating or coating materials in the environment of use. Deposits of water, dust, dirt, and debris on the RSM, and especially accumulations over the microphone portion, often interfere with voice reception and transmission by the microphone, causing garbling or muffled radio communication.

As generally shown in FIG. 3a-3b, and FIGS. 4a-4k, as protective covering apparatus 10 is provided for use with radio microphones such as RSM units 100. In an example, the covering apparatus 10 is made from a breathable woven textile having PTFE fibers and coatings to resist penetration by water. The covering apparatus 10 shown is sized and positioned to cover the microphone area typically provided on the front of the RSM unit 100, without interfering with normal operation and mounting of the RSM unit 100. To accomplish its stated purposes, the covering apparatus 10 includes a front body portion 12 that substantially surrounds the front (exposed portion) of the RSM. In this example, the covering, apparatus 10 further includes to rear body portion 14 that is connected to the front body portion 12 to secure the front body portion 12 in its desired position. The rear body portion 14 also surrounds at least part of the side and/or rear portion of the RSM 100. The rear body portion 14 preferably includes fastening means to secure the covering apparatus 10 to the RSM unit 100. Fastening means may include a first fastener 20 that surrounds or otherwise engages the cord transition portion 110 of the RSM, and/or the cord 112 that attaches the RSM unit 100 to a radio unit 200. Fastening means may further include a second fastener 30 provided adjacent any mounting means (such as a factory shoulder mount clip) provided on the rear or side portion of the RSM. Suitable fastening means for the first fastener 20 and second fastener 30 include, but are not limited to, hook and loop type fasteners, elastic fasteners, buttons, snaps, zippers, sliders, cords, adhesives, slots, tabs, rivets, screws, bolts, and/or nuts, for example. The rear body portion 14 may include cutouts, flaps, holes, or other means for fitting of the cover apparatus 10 around or in proximity to any mounting means provided on the RSM unit 100, without interfering with the desired mounting of the RSM unit 100. Once installed, as shown in FIG. 4k, the apparatus 10 fits snugly around the RSM unit 100, with fastening means such as first fastener 20 securely engaging the cord transition portion 110 and/or cord 112, and with the back portion 14 allowing access to the rear mounting clip of the RSM unit 100.

In this embodiment, with the protective covering 10 installed and secured as shown in FIG. 4k, and with the RSM unit 100 mounted on a shoulder mount clip of a user as generally shown in FIG. 2, the RSM unit 100 and user were doused with spray from a standard fire hose from a distance of about 2 feet for up to 1 minute. The user then activated the RSM unit by and the command receiver acknowledged clear voice communication with no garbling. In contrast, in similar water testing without the protective covering 10, the user's voice communication was confirmed by the command receiver as garbled. It was then confirmed that the garbling was the result of water accumulated on the RSM unit 100 because when the user shook the RSM unit, the water escaped and communications resumed to normal. Thus, the protective covering 10 was confirmed to eliminate or reduce the unacceptable garbling of radio communications that otherwise results in firefighting conditions involving water. Similarly, the covering prevents accumulation of dust and debris on an RSM unit 100 that can otherwise lead to garbling.

While this description is made with reference to exemplary embodiments, it will be understood by those skilled in the art that various changes may be made and equivalents may be substituted for elements thereof without departing from the scope. In addition, many modifications may be made to adapt a particular situation or material to the teachings hereof without departing from the essential scope. Also, in the drawings and the description, there have been disclosed exemplary embodiments and, although specific terms may have been employed, they are unless otherwise stated used in a generic and descriptive sense only and not for purposes of limitation, the scope of the claims therefore not being so limited. Moreover, one skilled in the art will appreciate that certain steps of the methods discussed herein may be sequenced in alternative order or steps may be combined. Therefore, it is intended that the appended claims not be limited to the particular embodiment disclosed herein.

1. An apparatus for protecting the microphone of a two-way communication radio, the apparatus comprising a protective covering configured and disposed to fit over a remote speaker microphone, the covering including a front portion comprising a textile that is permeable to sound but resistant to water, dust and debris, the covering further comprising fastening means for securing the covering to the remote speaker microphone.

2. The apparatus of claim 1, wherein the textile further includes a back portion configured and disposed to secure the covering to a housing of the remote speaker microphone.

3. The apparatus of claim 1, wherein the textile comprises a waterproof membrane layer.

4. The apparatus of claim 3, wherein the membrane layer comprises polytetrafluorethylene.

5. The apparatus of claim 1, wherein the textile further includes a back portion configured and disposed to secure the covering to a housing of the remote speaker microphone, and wherein the fastening means comprises a first fastening means for securing the covering to at least one of a housing of the remote speaker microphone or a cord connected to the remote speaker microphone.

6. The apparatus of claim 5, wherein the fastening means comprises a first fastening means for securing the covering to cord connected to the remote speaker microphone.

7. The apparatus of claim 5, wherein the first fastening means comprises at least one fastener selected from the group consisting of hook and loop fasteners, elastic fasteners, twist-type fasteners, cords, snaps, buttons, and adhesives.

8. The apparatus of claim 7, further comprising a second fastener for engaging the housing portion of the remote speaker microphone.

9. A method of preventing accumulation of water, dust or debris on a remote speaker microphone, the method comprising the step of installing the protective covering of claim 1 onto the remote speaker microphone.

10. The method of claim 9, wherein the step of installing comprises removably installing the protective covering of claim 1 onto the remote speaker microphone.
